(19) United States
(12) Patent Application Publication
(10) Pub. No.: US 2026/0230393 A1
(43) Pub. Date: Aug. 6, 2026

(54) METHOD AND APPARATUS FOR FEDERATION MANAGEMENT

(71) Applicant: Samsung Electronics Co., Ltd., Suwon-si, Gyeonggi-do (KR)

(72) Inventors: Deepanshu GAUTAM, Bangalore (IN); Ashutosh KAUSHIK, Bangalore (IN)

(21) Appl. No.: 19/124,238

(22) PCT Filed: Oct. 24, 2023
(86) PCT No.: PCT/KR2023/016570

§ 371 Date: Apr. 24, 2025

(30) Foreign Application Priority Data
Oct. 24, 2022 (IN) 202241060645
Nov. 2, 2022 (IN) 202241062637
Oct. 5, 2023 (IN) 202241060645

(51) Int. Cl. H04L 41/14; H04L 41/0233; H04L 67/289

(52) U.S. Cl. CPC H04L 41/145; H04L 41/0233; H04L 67/289

(57) ABSTRACT

The disclosure relates to a 5G or 6G communication system for supporting a higher data transmission rate. Embodiments herein disclose a method of federation management. The method comprises establishing a network resource model (NRM) for facilitating edge federation between an originating operator and a participating operator, and enabling the originating operator to use edge resources of the participating operator.

### TECHNICAL FIELD

The present disclosure relates to the field of communication technologies. Particularly, but not exclusively, the present disclosure relates to method and system for federation management.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Solution to Problem

One or more shortcomings discussed above are overcome, and additional advantages and features are provided by the present disclosure. Other embodiments and aspects of the disclosure are described in detail herein and are considered a part of the disclosure.

In one non-limiting embodiment of the present disclosure, method of federation management is disclosed. The method comprises establishing a network resource model (NRM) for facilitating edge federation between an originating operator and a participating operator, and enabling the originating operator to use edge resources of the participating operator.

In another non-limiting embodiment of the present disclosure, for establishing the NRM to facilitate the edge federation between the originating operator and the participating operator, the method comprises step of sending, by a first entity of the originating operator, a federation request to the participating operator, wherein the federation request indicates a request for using the edge resources of the participating operator. The method further comprises the step of receiving, by the first entity of the originating operator, a federation response from the participating operator based on the federation request, wherein the federation response comprises information pertaining to facilitating the edge federation. Further, the method comprises sending, by the first entity of the originating operator, NRM creation request to a second entity of the originating operator based on the federation response. Further, the method comprises the step of establishing, by the second entity of the originating operator, the NRM based on the NRM creation request.

In another non-limiting embodiment of the present disclosure, the edge resources comprises at least one of Edge Application Server (EAS), Edge Enabler Server (EES), Edge Hosting Environment (EHE).

In another non-limiting embodiment of the present disclosure, the NRM established comprises instances of a plurality of Instance Object Class (IOC) such that each IOC comprises a plurality of attributes and corresponding plurality of attribute values for supporting the edge federation between the originating operator and the participating operator.

In another non-limiting embodiment of the present disclosure, the instances of the plurality of IOCs comprises at least one of EdgeFederation IOC, OperatorEdgeFederation IOC, and OperatorEdgeDataNetwork IOC.

In another non-limiting embodiment of the present disclosure, the plurality of attributes, associated with the OperatorEdgeFederation IOC, comprise at least one of federationID, federationExpiry, originatedOPiD, participatingOPiD, initiationTime, offeredAvailabilityZones, and acceptedAvailabilityZones.

In another non-limiting embodiment of the present disclosure, for establishing the NRM, the method further comprises the step of sending, by the first entity of the originating operator, a zone registration request to the participating operator based on the federation response. The method comprises the step of receiving, by the first entity of the originating operator, a zone registration response indicating acceptance of the zone registration request for availing the edge services.

In another non-limiting embodiment of the present disclosure, the method further comprises modifying the NRM, by the second entity of the originating operator, upon receiving a modification request from the first entity of the originating operator

In another non-limiting embodiment of the present disclosure, a system for federation management is disclosed. The system comprises one or more processors to establish a network resource model (NRM) for facilitating edge federation between an originating operator and a participating operator, and enable the originating operator to use edge resources of the participating operator.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an exemplary environment illustrating federation management, in accordance with some embodiments of the present disclosure;

FIG. 2 illustrates a detailed block diagram 200 illustrating the system 202 in accordance with some embodiments of the present disclosure;

FIG. 3 illustrates a first exemplary Natural Resource Model (NRM) relationship diagram 300 for edge federation in an embodiment of the present disclosure;

FIG. 4 illustrates a second exemplary Natural Resource Model (NRM) relationship diagram 400 for edge federation in an embodiment of the present disclosure;

FIG. 5 illustrates an exemplary sequence diagram 500 for edge federation in an embodiment of the present disclosure;

FIG. 6 illustrates a flowchart of a method 600 for federation management, in accordance with some embodiments of the present disclosure; and

FIG. 7 illustrates a procedural flow diagram depicting trail of NRM fragments to be instantiated with a particular instantiation request, in accordance with some embodiments of the present disclosure.

FIG. 8 illustrates a block diagram of a network entity, in accordance with some embodiments of the present disclosure.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms like “at least one” and “one or more” may be used interchangeably throughout the description. The terms like “a plurality of” and “multiple” may be used interchangeably throughout the description. The terms like “federation”, “edge federation” and “federation of edge networks” may be used interchangeably throughout the description. The terms like “Network Resource Model” and “NRM” may be used interchangeably throughout the description. The terms like “network operator”, “operator”, and “service provider” may be used interchangeably throughout the description. The terms like “Instant Object Class” and “IOC” may be used interchangeably throughout the description. The terms like “first entity of the originating operator” and “provisioning MnS consumer” may be used interchangeably throughout the description. The terms like “second entity of the originating operator” and “provisioning MnS producer” may be used interchangeably throughout the description. The terms like “edge resources” or “edge resources of participating operator” may be used interchangeably throughout the description.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

3rd Generation Partnership Project (3GPP) SA6 is working on an architecture for enabling edge computing (3GPP TR 23.558), which specifies an application framework or an enabling layer platform to support edge computing in 3GPP specified networks, (for e.g., discovery of edge services, authentication of the clients, and the like). This includes interactions between a User Equipment (UE) and enabling layer platform, and interactions between applications deployed over edge and the enabling layer platform. Further, it includes facilitating integration with the underlying 3GPP core network. This involves defining Edge Application Server (EAS) or Edge Application (EA) as a piece of software running and deployed on virtual infrastructure at the edge of the 3GPP network.

Further, 3GPP SA5 has defined management aspect of edge network including lifecycle management, provisioning, performance, and fault management for edge nodes. It has defined the edge Network Resource Model (NRM) as part of TS 28.538 consisting of EdgeDataNetwork Instant Object Class (IOC) representing an edge data network as defined by SA6. EdgeDataNetwork<<IOC>> serves a defined location and contain multiple Edge Application Server (EAS) and Edge Enabler Server (EES).

Global System for Mobile communications Association (GSMA) Operator Platform Group (OPG) define requirements for an operator platform enabling edge computing. Focusing on edge computing, it provides a target architecture and requirements to enable an end-to-end delivery chain for different services. The interaction of the entire ecosystem involved in edge computing application delivery is covered. That is, for instance, from developers providing their applications to the system, to the deployment of resources in clouds and networks, the interaction of potentially multiple operators to deploy the applications, and finally, to customers who may and interact with the application.

The present invention includes defining the following NRM as part of edge NRM. The EdgeFederation IOC is defined as the IOC representing the set of federation maintained by the originating operator. The OperatorEdgeFederation IOC contains attributes to support the edge federation. An instance of OperatorEdgeFederation IOC is created and configured for each federation to be maintained. When configured, attributes override those in parent EdgeFederation instance. The OperatorAvailabilityZone IOC contains attributes to support an Availability Zone (AZ) available with the originating operator. An instance of OperatorAvailabilityZone IOC is created and configured for each available AZ. When configured, the attributes override those in the associated AvailabilityZone instance. The OperatorEdgeDataNetwork IOC contains attributes to support an edge data network available. An instance of OperatorEdgeDataNetwork IOC is created and configured for each EDN available in an AZ. When configured, the attributes override those in the associated EdgeDataNetwork instance.

Edge Federation (EF) is considered to be crucial requirement for Fifth Generation (5G) edge network management. 3GPP 5G network management is performed using model driven approach where everything to be managed should be supported by the 5G NRM (Network Resource Model). Existing edge NRM (Natural Resource Model) does not support federation of edge networks from different operators. The federation of edge networks requires inclusion of edge networks provided by different operators in a particular implementation of 5G edge NRM. The interface to manage (create, update, remove and query) federation is defined by GSMA. However, the NRM for federation and its constituents, i.e., availability zone and EDN, is not defined in 3GPP 5G NRM.

Further, the present 5G network management is using model driven approach, where all the managed elements have their Network Resource Model (NRM) classes that need to be instantiated when required. The elements to be managed include 5GC and RAN nodes. The NRMs are not only defined for managed elements but for OAM automation and control functionalities as well. 3GPP TS 28.622 defined are generic NRM whereas TS 28.541 defines the NRM specific to 5G management and orchestration. The generic NRM defines several NRM control fragments for various purpose. Some of the fragments are related and should be instantiated in a sequence to achieve the overall objective. For example, a consumer requesting to instantiate PerfMetricJob or TraceJob should also request to instantiate NtfSubscriptionControl in order to receive related notification with the required performance metrics. In another example, a ThresholdMonitor will require a related PerfMetricjob which in turn will require a NtfSubscriptionControl. A consumer need to explicitly request for all three. In another example, a consumer requesting to instantiate EdgeFederation should also request to instantiate OperatorEdgeFederation, AvailabilityZone, OperatorAvailabilityZone, etc. in order to establish NRM for the edge federation. The consumer needs to explicitly request for all these fragments. It is not optimal for the consumer to explicitly request for the instantiation of all required NRM fragments.

Thus, there is a requirement that the producer should instantiate all required NRM fragments with a single request i.e. the request to instantiate ThresholdMonitor or EdgeFederation in the above examples. The current standards lacks a mechanism for a producer to know what are the related NRM fragments that need to be instantiated after the parent NRM fragments is instantiated.

The present invention includes defining following Natural Resource Model (NRM) as part of edge NRM. The EdgeFederation IOC is defined as an IOC representing a set of federation maintained by an originating operator. The OperatorEdgeFederation IOC contains attributes to support the edge federation. An instance of OperatorEdgeFederation IOC may be created and configured for each federation to be maintained. When configured, attributes may override those in parent EdgeFederation instance. The OperatorAvailabilityZone IOC contains attributes to support an availability zone available with the originating operator. An instance of OperatorAvailabilityZone IOC may be created and configured for each available availability zone. When configured, the attributes override the associated AvailabilityZone instance. The OperatorEdgeDataNetwork IOC contains attributes to support an edge data network available. An instance of OperatorEdgeDataNetwork IOC may be created and configured for each EDN available in an availability zone. When configured, the attributes override those in the associated EdgeDataNetwork instance.

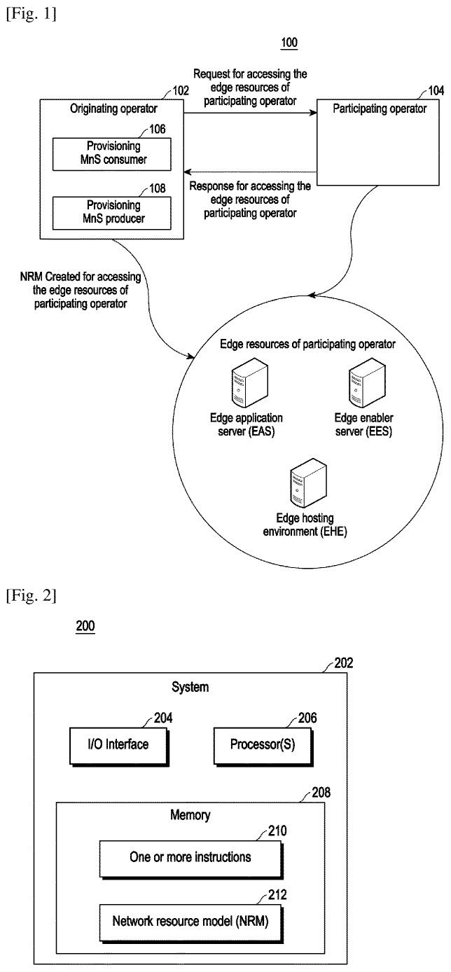

FIG. 1 shows an exemplary environment illustrating federation management, in accordance with some embodiments of the present disclosure. The environment 100 comprises an originating operator 102 and a participating operator 104. Though this specification, for simplicity and consistency, considers only a single originating operator 102 and a single participating operator 104 connected with each other, those of ordinary skill in the art will appreciate that there may be n number of originating operators which may be connected with n number of participating operators. Those of ordinary skill in the art will also appreciate that the single originating operator may simultaneously request ‘n’ number of participating operators for assessing their edge services. The originating operator 102 may comprise provisioning MnS consumer 106 and provisioning MnS producer 108. Both, the provisioning MnS consumer 106 and provisioning MnS producer 108 are separate entities of the originating operator 102 capable of performing various functionalities of the originating operator 102. For example, the provisioning MnS consumer 106 is present in operational support system (OSS) domain and interacts with other operators using application programming interface (APIs) defined as per GSMA in E/WBI APIs v0.9. Generally, the provisioning MnS consumer 106 performs all the requesting related operations for the originating operator 102. Whereas, the other entity i.e. provisioning MnS producer 108 is present in a management domain and deals with the management of Network Resource Model (NRM), for example, creating, deleting, and modifying the NRM. On the other side, the participating operator 104 comprises various edge resources which includes, but not limited to, Edge Application Server (EAS), Edge Enabler Server (EES), and Edge Hosting Environment (EHE). These edge resources provides various edge services i.e. the services which are kept basically at the edge of the network which is near to the user, so that the latency time is taken care of. The operators can provide edge services defined by SA6-3GPP TS 23.558.

As described above, the originating operator 102 is an operator who wants to use the edge resources and corresponding edge services of the participating operator 104. For enabling the originating operator 102 to use the edge resources and edge services of the participating operator 104, the present disclosure discloses a technique of establishing a network resource model (NRM) for facilitating edge federation between the originating operator 102 and the participating operator 104. Hence, the technique disclosed in the present disclosure belongs to SA5 group which defines the management (create, delete, modify, configure) of the architecture (EAS, EES, EEE) of the edge services. The architecture contains components like Edge Application Servers (EAS), Edge Enabler Server (EES) and Edge Hosting Environment (EHE).

The functioning of the provisioning MnS consumer 106 and provisioning MnS producer 108 of the originating operator 102 is implemented using a system 202 as shown in FIG. 2. According to embodiments of the present disclosure, the functioning of the provisioning MnS consumer 106 and the provisioning MnS producer 108 can be implemented using a common system 102. However, according to another embodiment, the functioning of the provisioning MnS consumer 106 and the provisioning MnS producer 108 can be implemented using separate systems 202.

FIG. 2 shows a detailed block diagram 200 illustrating the system 202 in accordance with some embodiments of the present disclosure. The system 102 may comprise an I/O interface 204, at least one processor 206, and a memory 208. The I/O interface 204 may be configured to send and receive request and response from other operators respectively. The memory 208 may be communicatively coupled to the at least one processor 206 and may store one or more instructions 210 executable by the processor 206. The memory 208 may also store the network resource model (NRM) 212 created for establishing the edge federation. The at least one processor 206 may be configured to perform one or more functions of the system 102 as described in the present disclosure.

The detailed working of the system 202 has now been explained in conjunction with FIG. 1 and using the below examples shown in table 1 and table 2. Initially, the provisioning MnS consumer 106 (alternatively referred as “first entity of the originating operator”) sends a federation request to the participating operator 104. The federation request indicates a request for using the edge resources of the participating operator 104. In response to the federation request, the provisioning MnS consumer 106 receives a federation response from the participating operator 104. The federation response comprises information pertaining to facilitating the edge federation. For example, “federationExpiry” information comes along with the federation response. The “federationExpiry” provides time limit when the federation relationship between the originating and participating operator will expire. Upon receiving the federation response, the provisioning MnS consumer 106 sends a NRM creation request to the provisioning MnS producer 108 (alternatively referred as “second entity of the originating operator”). While sending the NRM creation request, the provisioning MnS consumer 106 provides sufficient information to the provisioning MnS producer 108 for creating the NRM. Finally, the provisioning MnS producer 108 creates or establishes the NRM 212 based on the NRM creation request. According to embodiments of the present disclosure, the provisioning MnS consumer 106 performs additional operations required for establishing the NRM 212. For example, the provisioning MnS consumer 106 sends a zone registration request to the participating operator 104 based on the federation response. In response to the zone registration request, the provisioning MnS consumer 106 receives a zone registration response from the participating operator 104 indicating acceptance of the zone registration request for availing the edge services. Thus, the NRM 212 is established using the information received in the zone registration response. According to further embodiments of the present disclosure, provisioning MnS producer 108 can also modify the NRM 212 upon receiving a modification request from the provisioning MnS consumer 106.

The NRM 212 established comprises instances of a plurality of Instance Object Class (IOC) such that each IOC comprises a plurality of attributes and corresponding plurality of attribute values for supporting the edge federation between the originating operator 102 and the participating operator 104. The instances of the plurality of IOCs comprises EdgeFederation IOC, OperatorEdgeFederation IOC, and OperatorEdgeDataNetwork IOC. Further, the plurality of attributes, associated with the OperatorEdgeFederation IOC, comprises at least one of federationID, federationExpiry, originatedOPiD, participatingOPiD, initiationTime, offeredAvailabilityZones, and acceptedAvailabilityZones. The above described IOCs and the attributes are explained using the below tables.

The present disclosure includes defining following NRM 212 as part of edge NRM. The EdgeFederation IOC is defined as an IOC representing a set of federation maintained by the originating operator 102. This IOC when instantiated represents a set of available federations. Table 1 below shows an exemplary representation for EdgeFederation IOC.

TABLE 1

| Attribute | | | | | | | |
|---|---|---|---|---|---|---|---|
| Name | S | C | IsRedable | isWritable | isInvariant | isNotifyable | Description |
| originatingOPiD | M | 1 | T | T | F | T | This identifies the |
| | | | | | | | originating |
| | | | | | | | operator. |

In the above table 1, the attribute “originatingOPiD” indicates the operator ID of the originating operator 102.

The another IOC i.e. OperatorEdgeFederation IOC contains attributes to support the edge federation. An instance of OperatorEdgeFederation IOC may be created and configured for each federation to be maintained provided by originating operator 102 and the participating operator 104. When configured, the attributes override those in parent EdgeFederation instance. The OperatorEdgeFederation IOC when instantiated represents a particular available federation. Table 2 below shows exemplary representation for OperatorEdgeFederation IOC.

TABLE 2

| Attribute | | | | | | | |
|---|---|---|---|---|---|---|---|
| name | S | C | isReadable | isWritable | isInvariant | isNotifyable | Description |
| federationID | M | 1 | T | T | F | T | This identifies |
| | | | | | | | the particular |
| | | | | | | | federation |
| | | | | | | | created. |
| federationExpiry | M | 1 | T | T | T | F | This defines the |
| | | | | | | | time post which |
| | | | | | | | the federation |
| | | | | | | | relationship |
| | | | | | | | shall expire. |
| originatedOPiD | M | 1 | T | T | F | T | This identifies |
| | | | | | | | the originating |
| | | | | | | | operator. |
| participatingOPiD | M | 1 | T | T | F | T | This identifies |
| | | | | | | | the participating |
| | | | | | | | operator. |
| initiation Time | M | 1 | T | T | F | T | Date and time of |
| | | | | | | | the federation |
| | | | | | | | initiated by the |
| | | | | | | | originating |
| | | | | | | | operator |
| offeredAvailabilityZones | M | 1 | T | T | F | T | List of |
| | | | | | | | Availability |
| | | | | | | | Zone partner |
| | | | | | | | operator is |
| | | | | | | | willing to share. |
| | | | | | | | The details of |
| | | | | | | | Availability |
| | | | | | | | Zone are |
| | | | | | | | defined in |
| | | | | | | | Samsung's IP: |
| | | | | | | | XXXXX |
| accepted AvailabilityZones | M | 1 | T | T | F | T | List of |
| | | | | | | | Availability |
| | | | | | | | Zone accepted |
| | | | | | | | by originated |
| | | | | | | | operator. The |
| | | | | | | | details of |
| | | | | | | | Availability |
| | | | | | | | Zone are |
| | | | | | | | defined in |
| | | | | | | | Samsung's IP: |
| | | | | | | | XXXXX |

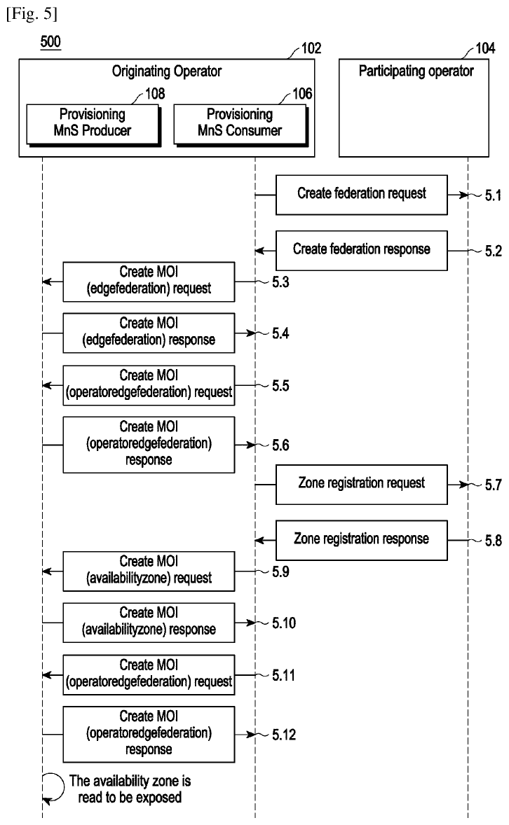

The above table 2, the attribute “federationID” is created at the time of creating NRM 212. The attribute “initiationTime” indicates a time when the originating operator 102 has initiated the federation request i.e. “Create Federation Request” (Step 5.1 of FIG. 5). The attribute “initiationTime” is an important because the originating operator 102 might wait for some time and collectively send the “CreateMOI (EdgeFederation) Request” for multiple participating operators in one go. Hence, the “initiationTime” helps in identifying or differentiating one participating operator from another participating operator. Further, the attribute “OfferedAvailabilityZones” indicates an area served by the participating operator 104 or area where the edge services are provided by the participating operator 104. The attribute “acceptedAvailabilityZones” indicates the area which is being accepted or required for using the edge services. In other words, the participating operator 104 may offer multiple availability zones for providing the edge services, however the originating operator 102 might require only few of the offered availability zones. Those of ordinary skill in the art will appreciate that the availability zone in both the “OfferedAvailabilityZones” and the “acceptedAvailabilityZones” is a geographical area comprising a Cell, latitude and longitude, or a convex polygon for providing the edge services.

In the above table 1 and table 2, the attribute characteristic “S” indicates support qualifier which could be mandatory (M) or non-mandatory. The attribute characteristic “C” indicates cardinality i.e. number of attributes being created. The attribute characteristic “isReadable” indicates whether the attribute is readable or not which is shown by true “T” and false “F”. The attribute characteristic “isWritable” indicates whether value can be provided at time of creation of the NRM. If it is not provided at the time of creation, then it is predefined. If the value can be provided then it is indicated by true “T” otherwise it will be indicated by false “F”. The attribute characteristic “isInvariant” indicates whether the value can be changed or not. If the value cannot be changed then it is indicated by false “F”. The attribute characteristic “isNotifyable” indicates that if somebody changes the attribute at organization level i.e. at the operator end, then such change is notifiable which is shown by true “T”.

Further, the another IOC i.e. OperatorAvailabilityZone IOC contains attributes to support an Availability Zone (AZ) available with the originating operator. An instance of OperatorAvailabilityZone IOC may be created and configured for each available AZ. When configured, the attributes override those in the associated AvailabilityZone instance. This IOC when instantiated represents a particular available AZ.

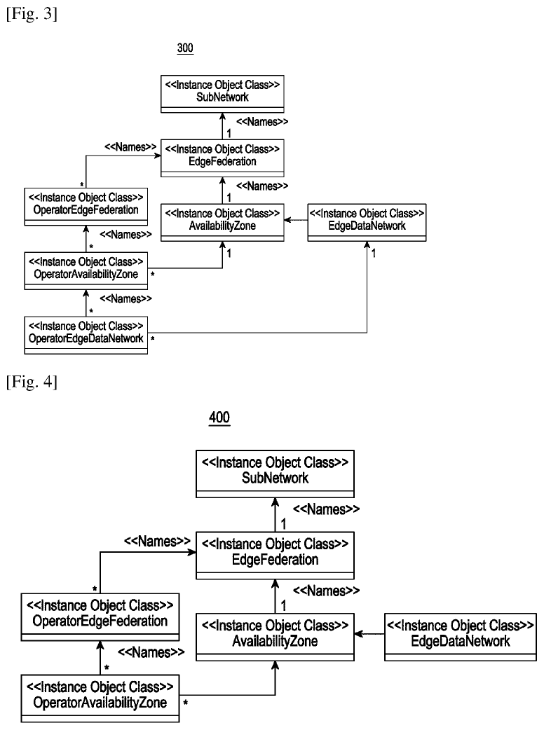

FIG. 3 illustrates a first exemplary Natural Resource Model (NRM) relationship diagram 300 for edge federation in an embodiment of the present disclosure.

The NRM fragment in FIG. 3 defines a first exemplary Natural Resource Model (NRM) relationship diagram showcasing federation of edge networks maintained by a particular operator. The EdgeFederation IOC is defined as the IOC representing the set of federation maintained by the originating operator. This IOC when instantiated represents a set of available federations. Multiple OperatorEdgeFederation IOC may be name contained in a single EdgeFederation IOC representing the information related with the federated edge network of another operator. Multiple OperatorAvailabilityZone IOC may be name contained in a single OperatorEdgeFederation IOC representing the information related with the AZ available with a federated operator. Multiple OperatorEdgeDataNetwork IOC maybe name contained in a single OperatorAvailabilityZone IOC representing the information related with the EDN of a federated operator.

FIG. 4 illustrate a second exemplary Natural Resource Model (NRM) relationship diagram 400 for edge federation in an embodiment of the present disclosure.

The NRM fragment in FIG. 4 defines a second exemplary NRM relationship diagram for the federation of edge networks maintained by a particular operator. The EdgeFederation IOC is defined as the IOC representing the set of federation maintained by the originating operator. This IOC when instantiated represents a set of available federations. Multiple OperatorEdgeFederation IOC may be name contained in a single EdgeFederation IOC representing the information related with the federated edge network of another operator. Multiple OperatorAvailabilityZone IOC may be name contained in a single OperatorEdgeFederation IOC representing the information related with the AZ available with a federated operator.

FIG. 5 illustrates an exemplary sequence diagram 500 for edge federation in an embodiment of the present disclosure. As shown, initially originating operator may send a create federation request (Step 5.1) to a Participating Operator (PO) as defined by GSMA in E/WBI APIs v0.9.

The PO may process the request and send the response (Step 5.2) as defined by GSMA in in E/WBI APIs v0.9. Further, the originating operators 102, behaving as provisioning MnS consumer 106 may send a createMOI request (Step 5.3) for EdgeFederation IOC in order to update the edge NRM reflecting the newly accepted edge federation. This IOC when instantiated represents a set of available federations. The originating operators 102, behaving as provisioning MnS consumer 106 may send a createMOI request (Step 5.5) for OperatorEdgeFederation IOC in order to update the edge NRM reflecting the newly accepted edge federation. This IOC when instantiated represents a particular available federation. The originating operator registers an Availability Zone (AZ) with PO as defined by GSMA in E/WBI APIs v0.9. Then, the PO may process the request and send the response as defined by GSMA in in E/WBI APIs v0.9.

Subsequently, the originating operators 102, behaving as provisioning MnS consumer 106 may send a createMOI request (Step 5.9) for availability zone AZ IOC in order to update the edge NRM reflecting the newly registered availability zone (AZ). This IOC when instantiated represents a set of available availability zones. The originating operators 102, behaving as provisioning MnS consumer 106 may send a createMOI request for OperatorAvailabilityZone IOC in order to update the edge NRM reflecting the newly registered Availability Zone. This IOC when instantiated represents a particular available AZ. In an embodiment, the AZ created may be exposed to the application providers on north bound interface.

FIG. 6 is a flow diagram illustrating an exemplary method 600 for federation management. The blocks of the flow diagram shown in FIG. 6 have been arranged in a generally sequential manner for ease of explanation; however, it is to be understood that this arrangement is merely exemplary, and it should be recognized that the functionality/processing associated with method 600 (and the blocks shown in FIG. 6) can occur in a different order (for example, where at least some of the functionality/processing associated with the blocks is performed in parallel and/or in an event-driven manner).

At step 602, the method recites sending, by a first entity 106 of the originating operator (alternatively referred as the “provisioning MnS consumer”), a federation request to the participating operator 104. The federation request indicates a request for using the edge resources of the participating operator 104.

At step 604, the method recites receiving, by the first entity 106 of the originating operator, a federation response from the participating operator 104 based on the federation request. The federation response comprises information pertaining to facilitating the edge federation. For example, “federationExpiry” information comes along with the federation response. The “federationExpiry” provides time limit when the federation relationship between the originating and participating operator will expire.

The method 600 at step 606 recites sending, by the first entity 106 of the originating operator, a NRM creation request to a second entity 108 of the originating operator (alternatively referred as the “provisioning MnS producer”) based on the federation response. While sending the NRM creation request, the first entity/provisioning MnS consumer 106 provides sufficient information to the second entity/provisioning MnS producer 108 for creating the NRM.

At step 608, the method recites establishing, by the second entity 108 of the originating operator, the NRM based on the NRM creation request. According to embodiments of the present disclosure, the provisioning MnS consumer 106 performs additional operations required for establishing the NRM. For example, the provisioning MnS consumer 106 sends a zone registration request to the participating operator 104 based on the federation response. In response to the zone registration request, the provisioning MnS consumer 106 receives a zone registration response from the participating operator 104 indicating acceptance of the zone registration request for availing the edge services. Thus, the NRM is established using the information received in the zone registration response. According to further embodiments of the present disclosure, provisioning MnS producer 108 can also modify the NRM upon receiving a modification request from the provisioning MnS consumer 106.

The NRM established comprises instances of a plurality of Instance Object Class (IOC) such that each IOC comprises a plurality of attributes and corresponding plurality of attribute values for supporting the edge federation between the originating operator 102 and the participating operator 104. The instances of the plurality of IOCs comprises EdgeFederation IOC, OperatorEdgeFederation IOC, and OperatorEdgeDataNetwork IOC. Further, the plurality of attributes, associated with the OperatorEdgeFederation IOC, comprises at least one of federationID, federationExpiry, originatedOPiD, participatingOPiD, initiationTime, offeredAvailabilityZones, and acceptedAvailabilityZones. The described IOCs and the attributes are explained in previous paragraphs using tables.

In this manner, the network resource model (NRM) may be established for facilitating edge federation between the originating operator and the participating operator such that the originating operator is enabled to use edge resources of the participating operator.

Further, to address the requirement that the producer shall instantiate all required NRM fragments with a single request i.e. the request to instantiate hresholdMonitor or EdgeFederation in the above examples, the present disclosure provides a mechanism for a producer to know what are the related NRM fragments that need to be instantiated after the parent NRM fragments is instantiated. In an embodiment, the present disclosure describes a mechanism using which an authorized consumer, while asking to create an MOI, can specify details on the IOC(s) that are to be instantiated next. In an implementation, the present disclosure describes a method to automatically instantiate the related IOC(s), with a single request for creation of the parent IOC. The present disclosure defines a new datatype “Trail Control”, which may be used to specify the trail of NRM fragments to be instantiated with a particular instantiation request. This will result in efficient 5G network management.

TrailControl <<datatype>>

This datatype defines the trail of IOC(s) to be instantiated once the parent (i.e., the IOC containing an attribute of type TrailControl) IOC is instantiated as table 3.

TABLE 3

| Attribute Name | S | C | isReadable | isWritable | isInvariant | isNotifyable | Description |
|---|---|---|---|---|---|---|---|
| nFTrailingStatus | M | 1 | T | T | F | T | This is a |
| | | | | | | | Boolean |
| | | | | | | | attribute |
| | | | | | | | specifying |
| | | | | | | | whether the |
| | | | | | | | trailing is |
| | | | | | | | enabled or not. |
| | | | | | | | The value TRUE |
| | | | | | | | specify that all |
| | | | | | | | the related NRM |
| | | | | | | | should be in- |
| | | | | | | | stantiated in a |
| | | | | | | | sequence after |
| | | | | | | | the parent MOI |
| | | | | | | | i.e the MOI |
| | | | | | | | containing an |
| | | | | | | | attribute of type |
| | | | | | | | <<TrailControl>>. |
| trailingCondition | M | 1 | T | T | F | T | It defines an |
| | | | | | | | event on which |
| | | | | | | | the trailing |
| | | | | | | | should be |
| | | | | | | | enabled. |
| | | | | | | | Example of |
| | | | | | | | event include |
| | | | | | | | threshold |
| | | | | | | | crossing event |
| nextInTrail | M | 1 | T | T | F | T | This defines an |
| | | | | | | | ordered list of |
| | | | | | | | NRM fragments |
| | | | | | | | to be instantiated |
| | | | | | | | next. |
| >nextIOC | M | 1 | T | T | F | T | This identifies |
| | | | | | | | the IOC. This |
| | | | | | | | will be a DN. |
| >attributes | M | 1 . . .* | T | T | F | T | This provides |
| | | | | | | | the name, value |
| | | | | | | | and constraints |
| | | | | | | | of the attributes |
| | | | | | | | for the IOC |
| | | | | | | | identified by |
| | | | | | | | nextIOC. This |
| | | | | | | | should contain |
| | | | | | | | information |
| | | | | | | | about all the at- |
| | | | | | | | tributes that |
| | | | | | | | satisfies the |
| | | | | | | | following |
| | | | | | | | criteria:defaultValue = |
| | | | | | | | None, |
| | | | | | | | multiplicity = 1 |
| | | | | | | | or 1 . . .* or *, Is- |
| | | | | | | | Nullable = False |
| >>name | M | 1 | T | T | F | T | This defines the |
| | | | | | | | name of the |
| | | | | | | | attribute |
| >>value | M | 1 | T | T | F | T | This defines the |
| | | | | | | | value of the |
| | | | | | | | attribute |
| >>constraints | O | 1 | T | T | F | T | The constraints |
| | | | | | | | for the attribute, |
| | | | | | | | if any. It applies |
| | | | | | | | only if the |
| | | | | | | | support qualifier |
| | | | | | | | is defined as CM |

FIG. 7 illustrates a procedural flow diagram depicting trail of NRM fragments to be instantiated with a particular instantiation request. The initial instantiation request and the information included in the request may be used for the instantiation of all the required NRM fragments. As shown in FIG. 7,

The provisioning MnS Consumer may request to instantiate Threshold Monitor IOC. The operation create MOI, as defined in 3GPP TD 28.532, may be used to instantiate Threshold Monitor IOC. The request may provide information related with all the IOC that need to be instantiated after the threshold Monitor is instantiated. The attribute Trail Control provides all that information.

The producer may send the response for the successful instantiation of Threshold Monitor IOC.

The producer may then check the TrailControl datatype to know which more IOCs should be instantiated and with what attributes.

The next steps may repeated for all the entries in the next InTrail attributes of the TrailControl MOI. The following steps assume PerfMetricJob to the first entry.

The producer may request to instantiate PerfMetricJob. The operation createMOI, as defined in 3GPP TD 28.532, may be used to instantiate PerfMetricJob. The values of all required attributes may be provided in TrailControl attribute received in step 1.

The producer may send the response for the successful instantiation of PerfMetricJob IOC.

The producer may request to instantiate NtfSubscriptionControl. The operation createMOI, as defined in 3GPP TD 28.532, may be used to instantiate NtfSubscriptionControl. The values of all required attributes may be provided in TrailControl attribute received in step 1.

The producer may send the response for the successful instantiation of NtfSubscriptionControl IOC.

Although the flow assumes that the TrailControl is included in thresholdMonitor IOC, it may be included in createMOI request for any IOC such as EdgeFederation IOC.

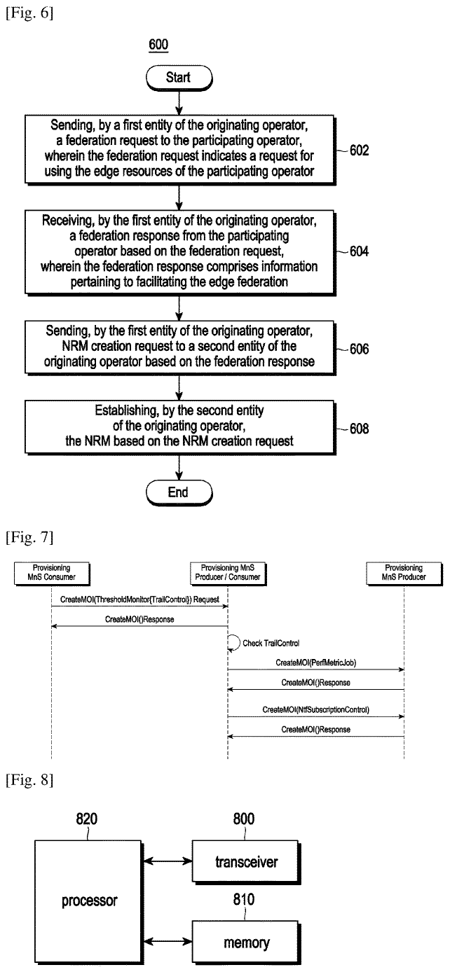

FIG. 8 illustrates a block diagram of a network entity, in accordance with some embodiments of the present disclosure.

The network entity of FIG. 8 comprises at least one network entity associated with at least one of an originating operator, a provisioning MnS producer, a provisioning MnS consumer, and participating operator.

The network entity according to an embodiment of the present disclosure may include a processor 820 that controls the overall operation of the network entity in the method as described above, a transceiver 800 including a transmitter and a receiver, and a memory 810. The present invention is not limited to the above example, and the network entity may include more or fewer configurations than the configuration shown in FIG. 8.

According to an embodiment of the present disclosure, the transceiver 800 may transmit and receive signals to and from network entities. In addition, the transceiver 800 can receive a signal through a wireless channel and output it to the processor 820, and transmit the signal output from the processor 820 through a wireless channel.

In an embodiment, an operator may share its edge network and services with another operator.

In an embodiment, an operator may deploy an application on the edge network provided by a different operator.

An embodiment of the present disclosure facilitates edge federation with 5G NRM.

An embodiment of the present disclosure manages the edge federation using generic provisioning Management Services (MnS).

In an embodiment, related IOC(s) may be instantiated automatically with a single request for creation of the parent IOC. The consumer does not have to explicitly request for the instantiation of all the required IOC(s). The consumer may include all required information in a single request. This results in efficient 5G network management.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to FIGS. 1-6 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., nontransitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise. The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the appended claims.

### REFERRAL NUMERALS

100 Environment
102 Originating Operator
104 Participating Operator
106 Provisioning MnS Consumer
108 Provisioning MnS Producer
202 System
204 I/O interface
206 Processor
208 Memory
210 Instructions
212 Network Resource Model (NRM)
300, 400 NRM Relationship Diagram
500 Sequence Diagram
600 Method
602-608 Method Steps

1-15. (canceled)

16. A method performed by a provisioning management service (MnS) consumer of an originating operator for federation management, the method comprising:
transmitting, to a provisioning MnS producer of the originating operator, a first request for edge federation instance object class (IOC); and
receiving, from the provisioning MnS producer, a first response in response to the first request,
wherein the edge federation IOC includes an identifier of the originating operator.

17. The method of claim 16, further comprising:
transmitting, to the provisioning MnS producer, a second request related to operating edge federation; and
receiving, from the provisioning MnS producer, a second response in response to the second request,
wherein the second request is associated with an operator edge federation IOC.

18. The method of claim 17, the operator edge federation IOC includes at least one of:
an identifier of a federation,
an expiration of the federation,
an identifier of the originating operator,
an identifier of a participating operator,
an initiation time of the federation,
offered availability zones, and
an accepted availability zones.

19. The method of claim 16, further comprising:
establishing a network resource model (NRM) for facilitating edge federation between the originating operator and a participating operator.

20. The method of claim 19, wherein establishing the NRM for facilitating the edge federation between the originating operator and the participating operator comprises:
transmitting, to the participating operator, a federation request for using edge resources of the participating operator; and
receiving, from the participating operator, a federation response based on the federation request, wherein the federation response comprises information pertaining to facilitating the edge federation.

21. The method of claim 19, further comprising:
enabling the originating operator to use edge resources included in the participating operator.

22. The method of claim 21, wherein the edge resources include at least one of an edge application server (EAS), an edge enabler server (EES), and an edge hosting environment (EHE).

23. The method of claim 19, wherein the NRM includes at least one instance of the edge federation IOC or instance of an operator edge federation IOC.

24. The method of claim 20, further comprising:
transmitting, to the participating operator, a zone registration request based on the federation response; and
receiving, from the participating operator, a zone registration response indicating acceptance of the zone registration request for availing edge services.

25. The method of claim 24, further comprising:
transmitting, to the provisioning MnS producer, modification request,
wherein the NRM is modified by the provisioning MnS producer upon receiving the modification request.

26. A provisioning management service (MnS) consumer entity of an originating operator entity for federation management, the provisioning MnS consumer entity comprising:
a transceiver; and
at least one processor coupled with the transceiver and configured to:
transmit, to a provisioning MnS producer entity of the originating operator entity, a first request for edge federation instance object class (IOC), and
receive, from the provisioning MnS producer entity, a first response in response to the first request,
wherein the edge federation IOC includes an identifier of the originating operator entity.

27. The provisioning MnS consumer entity of claim 26, wherein the at least one processor is further configured to:
transmit, to the provisioning MnS producer entity, a second request related to operating edge federation, and
receive, from the provisioning MnS producer entity, a second response in response to the second request,
wherein the second request is associated with an operator edge federation IOC.

28. The provisioning MnS consumer entity of claim 27, wherein the operator edge federation IOC includes at least one of:
an identifier of a federation,
an expiration of the federation,
an identifier of the originating operator entity,
an identifier of a participating operator,
an initiation time of the federation,
offered availability zones, and
an accepted availability zones.

29. The provisioning MnS consumer entity of claim 26, wherein the at least one processor is further configured to:
establish a network resource model (NRM) for facilitating edge federation between the originating operator entity and a participating operator entity.

30. The provisioning MnS consumer entity of claim 29, wherein the at least one processor is further configured to:
transmit, to the participating operator entity, a federation request for using edge resources of the participating operator entity, and
receive, from the participating operator entity, a federation response based on the federation request, wherein the federation response comprises information pertaining to facilitating the edge federation.

31. The provisioning MnS consumer entity of claim 29, wherein the at least one processor is further configured to:
enabling the originating operator entity to use edge resources included in the participating operator entity.

32. The provisioning MnS consumer entity of claim 31, wherein the edge resources include at least one of an edge application server (EAS), an edge enabler server (EES), and an edge hosting environment (EHE).

33. The provisioning MnS consumer entity of claim 29, wherein the NRM includes at least one instance of the edge federation IOC or instance of an operator edge federation IOC.

34. The provisioning MnS consumer entity of claim 30, wherein the at least one processor is further configured to:
transmit, to the participating operator entity, a zone registration request based on the federation response, and
receive, from the participating operator entity, a zone registration response indicating acceptance of the zone registration request for availing edge services.

35. The provisioning MnS consumer entity of claim 34, wherein the at least one processor is further configured to:
transmit, to the provisioning MnS producer entity, modification request,
wherein the NRM is modified by the provisioning MnS producer entity upon receiving the modification request.
